(19) United States
(12) Patent Application Publication
(10) Pub. No.: US 2015/0041134 A1
(43) Pub. Date: Feb. 12, 2015

(54) Cement Slurry Compositions and Methods

(71) Applicant: Schlumberger Technology Corporation, Sugar land, TX (US)

(72) Inventors: Clara Carelli, Cambridge (GB); Jesse C. Lee, Sugar Land, TX (US); Syed A. Ali, Sugar Land, TX (US); Isabelle Couillet, Paris (FR); Claire Giraudeau, Clamart (FR)

(21) Appl. No.: 14/484,221

(22) Filed: Sep. 11, 2014

Related U.S. Application Data
(63) Continuation-in-part of application No. 13/776,877, filed on Feb. 26, 2013, now abandoned.

(51) Int. Cl. E21B 33/14; C09K 8/44

(52) U.S. Cl. CPC E21B 33/14; C09K 8/44
USPC 166/293; 524/8

(57) ABSTRACT

A cement slurry composition is described as having cement, water, and organic polymer particles. The composition also includes non-ionic surfactants, which may contain ethoxylate groups or contain both ethoxylate groups and propoxylate groups in the hydrophilic part. The non-ionic surfactant acts to disperse the hydrophobic polymeric particles in the slurry, thereby reducing mixing time. The cement slurry composition is prepared and then pumped into the subterranean well and placed in a zone of the subterranean well. Time is then allowed for the cement slurry composition to set and form a solid mass in the zone.

### BACKGROUND

The statements in this section merely provide background information related to the present disclosure and may not constitute prior art.

The present disclosure relates generally to compositions and methods for treating or completing a subterranean well having a borehole. More particularly, the disclosure relates to cement slurry compositions for cementing a subterranean well and, in the alternative, methods for subterranean well completions and/or cementing a subterranean well having a borehole. The present disclosure also relates to cement-slurry compositions and methods for preparing cement slurry compositions having hydrophobic polymer particles as additives.

In a typical well cementing operation, a cement slurry is prepared at the surface and then pumped into the subterranean well through a liner or casing to fill the annulus between the casing and borehole wall. Once the slurry sets, the cement may provide a number of functions, including providing zonal isolation and segregation, corrosion control, and structural support. A properly prepared slurry and set cement form a strong, nearly impermeable seal around the casing.

Generally, the cement slurry should have relatively low viscosity to facilitate pumping and maintain effectively constant rheological properties during both preparation at the surface and delivery into the well and the target zone. Assuming the cement slurry is properly prepared and delivered to the target zone, the properties of the set cement will depend primarily on the components of the slurry and the additives included in the slurry composition. Ideally, the properly placed cement will develop high compressive strength in a minimum of time.

In recent years, organic polymeric particles have been employed as additives in the cement slurry to achieve or enhance certain cement properties. Generally, the addition of the polymeric particles leads to improved joining of the slurry constituents, which may help achieve improved strength and durability characteristics, among other things. The hydrophobic character of the particles may, however, also present some undesirable issues. In particular, mixability and foaming problems may be observed in the polymer-modified cement slurry.

In the field, cement slurries are often prepared using the continuous mixing method, also known as mixing on-the-fly. Solid blends are mixed with water and liquid additives by using a jet mixer. The jet mixer generates a regulated flow of solids that creates a void to draw a dry powder component (due to a venturi effect) into the mix. Unfortunately, the drawing action also draws and entrains air in the slurry. If allowed to stabilize, excess air in the slurry can lead to densely packed air bubbles collecting and then forming at the slurry surface, i.e., foaming Excessive entrained air and foam can adversely affect the slurry design. For example, it can alter the slurry composition and performance, including deviating from optimal slurry density or increasing slurry viscosity. Such conditions may also cause pumping problems and inefficiencies. Operators attempt to mechanically remove as much of the entrained air from the slurry before pumping, often through further mixing. However, for slurries containing a large amount of hydrophobic polymer particles, such de-aerating efforts often fall short of removing enough of the entrained air from the slurry to avoid slurry quality issues or pumping problems.

To mitigate foaming problems in cement slurry preparations, different traditional measures are available. Anti-foam and defoamer additives may be added to the slurry to prevent or minimize foaming. Separator equipment may also be used in conjunction with traditional slurry mixers to mechanically remove the entrained air from the slurry. For example, the SlurryAirSeparator device from Schlumberger Ltd. employs a hydrocyclone mechanism to separate and remove entrained air from the cement slurry. As another option, the slurry may be transferred to a large tank for batch mixing. Much of the remaining entrained air may be removed from the slurry. While any of the aforementioned options may be effective in reducing entrained air and foam in the slurry, the employment of these options may not be feasible. For example, operating time and cost associated with using additional equipment or additives may not be acceptable, or the equipment may not be readily available in some field locations. Also, some of these measures have proven less than satisfactory in reducing entrained air and foam under certain operating conditions. Thus, there remains a need for methods and/or compositions that reduce, eliminate, or prevent air entrainment and foaming conditions in cement slurries for wellbore completions.

### SUMMARY

The present disclosure is directed to cement slurry compositions having polymeric particles.

Embodiments relate to methods for improving the mixability of cement slurries comprising hydrophobic organic particles. Further embodiments relate to methods for cementing or completing subterranean wells comprising a borehole.

In an aspect, embodiments relate to compositions comprising an inorganic cement, water, organic polymeric particles and a non-ionic surfactant. The particles have an average particle size between 1 micron and 1000 microns.

In a further aspect, embodiments relate to methods for cementing a subterranean well comprising a borehole. A cement slurry composition is prepared and placed in a zone of the subterranean well. The cement slurry comprises an inorganic cement, water, organic polymer particles and a non-ionic surfactant. The particles have an average particle size between 1 micron and 1000 microns. The cement slurry is then allowed to set and form a solid mass in the zone.

In yet a further aspect, embodiments relate to methods for improving the preparation of a cement slurry composition having hydrophobic particles therein for introduction into a subterranean well. A dry blend is prepared that comprises an inorganic cement and organic polymer particles. The particles have an average particle size between 1 micron and 1000 microns. A non-ionic surfactant is added to a water solution. A continuous mixing method is then used to mix the dry blend into the water solution. The non-ionic surfactant acts to disperse the polymer particles in the solution.

### BRIEF DESCRIPTION OF THE DRAWINGS

Embodiments may be understood with the appended drawings.

FIG. 1 is a graphical illustration displaying contact angle measurements for various aqueous solutions containing different concentrations of non-ionic surfactants;

FIG. 2 is a graphic illustration displaying the relative volume increase over time for various aqueous solutions after mixing; and

FIG. 3A is a photograph of a water suspension of rubber particles in the absence of a non-ionic surfactant.

FIG. 3B is a photograph of a water suspension of rubber particles in the presence of a non-ionic surfactant.

### DETAILED DESCRIPTION

At the outset, it should be noted that in the development of any such actual embodiment, numerous implementation—specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the cement slurry composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any concentration within the range, including the end points, is to be considered as having been stated. For example, a “range of from 1 to 10” is to be read as indicating each possible number along the continuum between about 1 and about 10. Thus, even if specific data points within the range, or even no data points within the range, are explicitly identified or refer to a few specific points, it is to be understood that inventors appreciate and understand that any and all data points within the range are to be considered to have been specified, and that inventors possessed knowledge of the entire range and all points within the range.

As described herein, cement slurry compositions and methods for preparation are provided in which organic polymeric particles and non-ionic surfactants are included as additives. The cement slurry compositions include a suitable amount of an inorganic cement and water to make up the base slurry composition, with particular consideration for an optimal balance of mechanical strength in the set cement and ideal viscosity and quality of the slurry. The organic polymeric particles may achieve or enhance a desired property in the slurry, the set cement or both. The non-ionic surfactants may improve dispersion of the hydrophobic particles into the slurry.

In an aspect, embodiments relate to compositions comprising an inorganic cement, water, organic polymeric particles and a non-ionic surfactant. The particles have an average particle size between 1 micron and 1000 microns. Or, the particles may have an average particle size between 30 microns and 1000 microns. Or, the particles may have an average particle size between 70 microns and 800 microns.

In a further aspect, embodiments relate to methods for cementing a subterranean well comprising a borehole. A cement slurry composition is prepared and placed in a zone of the subterranean well. The cement slurry comprises an inorganic cement, water, organic polymer particles and a non-ionic surfactant. The particles have an average particle size between 1 micron and 1000 microns. Or, the particles may have an average particle size between 30 microns and 1000 microns. Or, the particles may have an average particle size between 70 microns and 800 microns. The cement slurry is then allowed to set and form a solid mass in the zone.

In yet a further aspect, embodiments relate to methods for improving the preparation of a cement slurry composition having hydrophobic particles therein for introduction into a subterranean well. A dry blend is prepared that comprises an inorganic cement and organic polymer particles. The particles have an average particle size between 1 micron and 1000 microns. Or, the particles may have an average particle size between 30 microns and 1000 microns. Or, the particles may have an average particle size between 70 microns and 800 microns. A non-ionic surfactant is added to a water solution. A continuous mixing method is then used to mix the dry blend into the water solution. The non-ionic surfactant acts to disperse the polymer particles in the solution.

For all aspects, the compositions are pumpable. To those skilled in art, “pumpable” slurries may be those whose viscosities are lower than 1000 cp at a shear rate of 100 s⁻¹.

For all aspects, the inorganic cement may comprises portland cement, calcium aluminate cement, lime-silica blends, fly ash, blast furnace slag, geopolymers, chemically bonded phosphate ceramics, or zeolites, or combinations thereof.

For all aspects, the composition may comprise about 10% to 50% by weight inorganic cement or cementious material and about 5% to about 40% by weight organic polymer particles. Further, the cement slurry composition may comprise about 0.05% to about 0.5% by weight non-ionic surfactant. In yet further compositions, particularly those with increasing amounts of additives (including hydrophobic organic polymer particles), the amount of non-ionic surfactant in the cement slurry composition may be as high as about 5% by weight. In other compositions, particularly those with minimum amounts of hydrophobic polymer particles and other additives, the amount of non-ionic surfactant may be as low as about 0.005% by weight.

For all aspects, the organic polymer particles may comprise one or more of the following: rubber particles, poly(acrylic) particles; poly(acrylonitrile) particles; poly(acrylamide) particles; maleic anhydride polymers; polyamides; polyimides; polycarbonates; polymers made from diene monomers; saturated and unsaturated polymers containing ester functionality in the main polymer chain, such as poly(ethylene terephthalate) (PET); polyurethanes′poly(propylene glycol); fluorocarbon polymers; polyethylene, polypropylene, their copolymers; polystyrene; poly(vinyl acetal); poly(vinyl) polymers; poly(vinylidene) chlorides; poly(vinyl acetate); poly(vinyl ether) and poly(ketone); unitaite (more commonly known as Gilsonite™, available from American Gilsonite Company); graphite; coals; and waxes. In certain compositions, the amount of hydrophobic organic polymer particles may be roughly 25% by weight of solid blend, which is relatively high, and in further embodiments, may be about 35% by weight of solid blend.

For all aspects, the non-ionic surfactant may comprise a hydrophilic part that comprises ethoxylate groups and propoxylate groups. The non-ionic surfactant may be octylphenol ethoxylate. The non-ionic surfactant may comprise between 4.5 and 12 moles of ethylene oxide. The non-ionic surfactant may have a hydrophilic-lipophilic balance (HLB) between 10 and 16. The organic polymer additive may be rubber particles, and the non-ionic surfactant may comprise ethoxylate groups and have an HLB value between 10 and 14.

For all aspects, the non-ionic surfactant may comprise surfactants containing ethoxylate groups, both ethoxylate and propoxylate groups, alkoxylates containing propylene oxides or alkoxylates containing butylene oxide, or combinations thereof.

For all aspects, the compositions may further comprise an anti-foam agent and a dispersant.

In the methods for cementing a well bore, a cement slurry composition is first prepared at the surface. Preparation of the cement slurry composition may entail preparing a dry blend of all the solids including the polymeric particles, and a wet blend that includes water and the nonionic surfactant. More additives may be included in the blends as generally known in the art and/or required by the particular cementing operation and wellbore conditions. The dry blend is then added to the wet blend in a standard mixing procedure using, for example, a jet mixer in a single pass operation and at standard mixing speed and time to sufficiently incorporate all the solids into the mixture.

After mixing, the cement slurry composition may be pumped into the well bore. The cement slurry may be delivered into the wellbore, filling the annulus between the drilled hole and the casing string. Once in place, the cement slurry is allowed to cure and harden. Once set, the cement may attain the mechanical properties intended by the design, including high strength. The set cement may also provide an impermeable seal about the casing.

The slurry compositions described herein may employ any one of the types of inorganic cements traditionally used for well completions. These include the more commonly used Portland cement that is produced from limestone and either clay or shale. The cement may meet the chemical and requirements of the American Petroleum Institute and conform to one of the API cement classifications. In any event, it should be understood that the type and formulation of the cement used in an application may depend on several factors, including the conditions expected downhole and the specific purposes or objectives of the cementing operation.

Surfactants are organic compounds that contain both hydrophobic groups (the tails) and hydrophilic groups (the heads). Surfactants diffuse in water and adsorb at interfaces between air and water or oil and water. The insoluble hydrophobic tail may extend out of the bulk water phase, e.g., into the oil phase, while the water soluble head may remain in the water phase. The alignment of the surfactants at the surface modifies the surface properties of water at the water/oil or water/oil interface. The class of surfactants selected and employed in the presently described compositions is non-ionic surfactants, which are characterized by a hydrophobic group or head that does not contain a net charge. In the bulk aqueous phase, surfactants form aggregates characterized by a hydrophobic group or tail that form the core and hydrophilic heads that typically surround the core and contact the surrounding liquid. The hydrophilic-lipophilic balance or HLB value of the surfactant is a measure of the degree to which the surfactant is hydrophilic or lipophilic, as determined by the relative sizes of the hydrophilic groups and hydrophobic groups.

Non-ionic surfactants may be selected that are soluble in water and exhibit chemical stability in the cement slurry composition (i.e., very high pH and ionic strength). Use of the selected surfactant in the cement slurry composition may also promote wettability of hydrophobic particles, a low foam generation or good defoaming effect, combined with dispersion of the hydrophobic particles in the solution. As shown further below, the selected non-ionic surfactant may contain both ethoxylate and propoxylate groups in the hydrophilic part. Other suitable non-ionic surfactants may include fatty alcohol alkoxylates that contain moles of propylene oxide or butylene oxide. This class of non-ionic surfactants may offer increased wettability results with a defoaming effect when the application temperature is higher than their cloud points.

Applicants have established that, when such non-surfactants are used as cement slurry additives in conjunction with hydrophobic organic polymer particles, the presence of foam in the cement slurry after mixing may be substantially reduced. In accordance with the present disclosure, selected nonionic surfactants may added to the cement slurry composition and, when mixed, increase the surface tension between water and air (or other types of gases), thereby de-stabilizing the foam (defoaming) or preventing the formation of foam (antifoaming). The surfactant tendency to de-foam may depend on several parameters: surfactant chemistry and structure; ratio between hydrophobic and hydrophilic part (higher hydrophobicity may lead to a lower foaming tendency); surfactant quantity; and the rate of absorption on a surface.

Moreover, without the addition of the non-ionic surfactants, air bubbles may be stabilized by the hydrophobic particle surfaces and accumulate between the particles. This may lead to a stable aggregation of particles and air bubbles which, among other things, may alter cement slurry density specifications and prevent proper mixing of the organic polymer particles. The selected non-surfactants may act as wetting agents that effectively reduce the surface tension between the hydrophobic particles and water. This may subsequently reduce the amount of air trapped at the particle surface and promote the dispersion of the hydrophobic particles in water. This dispersion may improve the mixability of the cement slurry containing the polymeric particles, and also may reduce the slurry's tendency to retain entrained air. As a result, the presence of foam in the slurry during preparation may be reduced and the cement slurry may be pumped into the well without further deaerating techniques.

The concentration of surfactant added to the cement slurry composition is dependent on the slurry formulation. More particularly, the surfactant concentration will be largely dependent on the amount of hydrophobic particles added to the composition and the surface area presented by the particles. Greater amounts and larger surface areas will warrant higher concentrations of surfactant to address mixability issues. It is noted that a given concentration of smaller particles in a cement slurry will present a greater total surface area than the same concentration made up of larger particles in the same cement slurry, and thus, require a higher concentration of surfactant. In one sense, methods and compositions according to the present disclosure allow for the use of not only greater concentrations of hydrophobic organic polymers in the slurry, but a greater number of polymers, which may be independently advantageous. In certain compositions, the amount of hydrophobic particles is roughly 25% by weight of solid blend, which is relatively high, but in some cases, this number can reach 35%.

Thus, in one aspect, the present disclosure provides methods for cementing and cement slurry preparation that allow higher concentrations of hydrophobic particles to be added to the slurry without encountering mixability and foaming issues. The inclusion of increased concentrations of hydrophobic particles may impart desirable or enhanced properties to the cement slurry or set cement that would not have been previously attainable. For example, with increased concentrations of certain polymeric particles, the cement slurry may swell more and achieve relatively greater volume, and be lighter, more flexible, elastic, lighter—all desirable properties. These improved properties may not have been achieved, however, if slurry mixability were an issue.

It is well known to those skilled in the relevant art that a variety of other components and additives may be included in the cement slurry compositions. These include fluid-loss additives, set retarding agents, dispersing agents, lightweight extenders, and the like. Slurry compositions described in this disclosure reveal some of these additives (e.g., Tables 1, 2 and 3 below). The inclusion of these additives and their effect on the non-ionic surfactant, the hydrophobic particles, and the cement slurry, in general, may be a relevant consideration in the selection of the types and amounts of non-ionic surfactants for the cement slurry composition.

To practice a method of cementing or prepare a well completion according to the present teachings, a solid or dry blend of cement and additives is prepared. The cement may be one of the various types in accordance with the API classes and suitable for the cementing application and with the various additives intended. In this embodiment, the additives include organic polymer particles, such as rubber particles, that have been selected to increase the flexural strength and ductility in the set cement. An aqueous solution is also prepared beginning with fresh water at an amount required for a suitable slurry composition and including one or more additives. In one embodiment, the additive mixed into the water is a non-ionic surfactant such as an octylpehenol ethoxylate (Triton™ X-45 or Triton™ X-102 from Dow Chemical Co. in Houston, Tex.) or an ethoxylate/propoxylate (Tergitol™ minfoam 2X from Dow Chemical Co.). The dry blend, containing all the solid additives is added to the water solution using a jet mixer, for example, to make the desired cement slurry. For more precision control, the blends may be batch mixed by circulating in a large tank and using a batch mixer.

As with most cement slurry preparations, the goal of the mixing process is to obtain a consistent slurry with the proper amount of additives and water, and at the target density. The optimal cement-water ratio is generally a balance between achieving maximum strength at complete hydration and having sufficient water volume to lower the viscosity of the slurry to pumpable levels. The viscosity may be reduced to facilitate pumping the cement slurry through the long narrow annulus of the wellbore.

Table 1 presents a cement slurry composition in accordance with one embodiment. The slurry contains a cement additive to prevent annular migration of gas into the cement slurry during critical hydration period. The cement additive is a suspension of polymer microgels, which form an impermeable filter cake that blocks gas migration. In this composition, the non-ionic surfactant is an alkoxylate surfactant.

TABLE 1
Cement Slurry Composition

| | | | | | |
|---|---|---|---|---|---|
| Job Type | Casing | Depth | 6000 feet | TVD | 6000 feet |
| | | | [1830 m] | | [1830 m] |
| BHST | 150° F. | BHCT | 115° F. | BHP | 3500 psi |
| | [66° C.] | | [46° C.] | | [21 MPa] |
| Starting | 80° F. | Time to | 00:33 hr: | Heating | 1.05° F./min |
| Temp.: | [27° C.] | Temp.: | | Rate: | [0.6° C./min] |
| Starting | 450 psi | Time to | 00:33 | Schedule: | 9.5-3 |
| Pressure: | [3.1 MPa] | Pressure: | hr:mm | | |

Composition

| | | | | | |
|---|---|---|---|---|---|
| Slurry Density | 12.89 lbm/gal | Yield | 1.46 ft³/sk | Mix Fluid | 4.624 gal/sk |
| | [1545 kg/m³] | | [970.6 L/tonne] | | [410 L/tonne] |
| Solid Vol. | 55.0% | Porosity | 45.0% | | |
| Fraction | | | | | |

| Code | Concentration | Sack Reference | Component | Blend Density |
|---|---|---|---|---|
| Cement Blend | | 100 lbm | Blend | 16.63 lbm/gal |
| | | [45.5 kg] | | [1.99 g/cm³] |
| | | of BLEND | | |
| Fresh Water: | 4.59 gal/sk | | Base Fluid | |
| | [407 L/tonne] | | | |
| Gas migration | 0.589 gal/sk | | Additive | |
| control additive: | [52.3 L/tonne] | | | |
| Anti-foam agent: | 0.030 gal/sk | | Antifoam | |
| | [2.47 L/tonne] | | | |
| Liquid dispersant: | 0.007 gal/sk | | Dispersant | |
| | [0.56 L/tonne] | | | |
| Non-ionic | 0.100 gal/sk | | | |
| surfactant: | [8.9 L/tonne] | | | |

### EXAMPLES

It should be recognized that the examples below are provided to aid in a general understanding of the present teachings. The examples should not be construed so as to limit the scope and application of such teaching to the content of the examples. It is noted that rubber particles were selected as the organic polymer particles in some of the examples and the experiments partly because rubber particles are frequently used as an additive in cement slurries for well completions and those skilled in the relevant art are likely to be familiar with the usage. In any case, the selection of rubber particles is provided to facilitate description, and the present description's focus on such use should not be deemed limiting of the proposed concepts and teachings. The proposed compositions and methods are also applicable to cement slurry compositions employing other hydrophobic polymer particles to achieve or enhance certain properties in the slurry or set cement.

The experiments were performed to illustrate the effect of different surfactants on the wettability of rubber particles in water solutions. For these experiments, several non-ionic surfactants were selected for inclusion in a cement slurry composition. Each of the selected surfactants is a product made commercially available by The Dow Chemical Company in Houston, Tex. The nonionic surfactants include the following: Triton™-X45, Triton™ X-102 and Tergitol™ MinFoam 2X. The characteristics of these products are reported in Table 1. The first two surfactants are octylphenol ethoxylate molecules which differ by the size of the hydrophilic head: Triton™ X-45 contains 4.5 moles of ethyleneoxide (EO) while 12 EO moles are present in Triton™ X-102. As a result, the two surfactants have a different hydrophilic-liphophilic balance: the HLB value is ≈10 for Triton™ X-45 while it is ≈14 for Triton™ X-102. The third surfactant has a different chemistry and contains both ethoxylate and propoxylate groups in the hydrophilic part. As reported in the Table 2, the non-ionic surfactant Tergitol™ MinFoam 2x presents an intermediate HLB value (≈12) and a much lower critical micelle concentration CMC (24 μM).

TABLE 2
Properties of Three Non-Ionic Surfactants

Surfactant

| | Triton ™ | Triton ™ | Tergitol ™ |
|---|---|---|---|
| | X-45 | X-102 | MinFoam |
| Chemistry | Octylphenol | Octylphenol | Ethoxylate |
| | Ethoxylate | Ethoxylate | Propoxylate |
| | EO | EO | |
| | moles: 4.5 | moles: 12 | |
| HLB | 10 | 14 | 12 |
| CMC (μM) | 136 | 267 | 24 |
| Surface Tension | 29 | 36 | 21 |
| (dynes/cm) 1% in | | | |
| water at 25° C. | | | |

The laboratory experiments presented in these examples were performed in accordance with recommended practices published by the American Petroleum Institute (API Publication RP10B).

### Example 1

The aim of a first experiment was to evaluate the effect of the selected surfactants on wettability, i.e., on the wettability of a surface of a polymer particle. For each selected surfactant, several water solutions each containing different amounts of the surfactant were prepared, including a first control solution that contained 0% surfactant concentration. The contact angle for each solution was measured using a Tracker tensiometer from Teclis. Because the measurement of contact angles on powders presents some experimental difficulties, contact angle measurements were carried out on rubber bands.

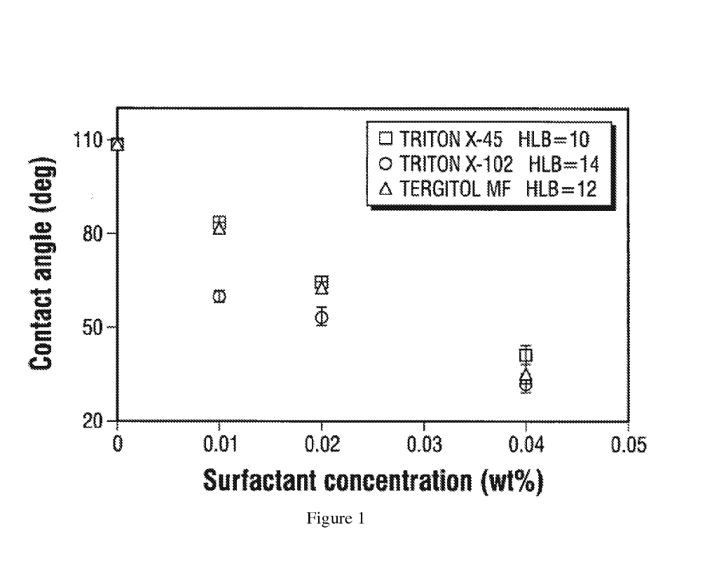

The results are presented in the graph of FIG. 1, in which the average measured contact angle is plotted as a function of the surfactant concentration in water for the different solutions tested. As shown, the value of the contact angle for a water solution without surfactant was 110°. This measurement for the first solution confirmed the poor wettability of the polymer surface. For the water solutions containing one of the surfactants, wettability with respect to the rubber surface was considerably improved. As illustrated by FIG. 1, the contact angle decreased as the amount of surfactant in the solution increased from 0.01% to 0.04% by weight. At 0.04 wt % concentration, the contact angle for each solution was reduced to about 25 degrees.

The results of this experiment show that the addition of the non-ionic surfactants to the water solutions improved the wettability of the water solution with respect to a rubber surface. The experimental results suggest, therefore, that the inclusion of the non-ionic surfactants to a cement slurry composition that incorporates rubber particles may improve the wettablity of the water solution-rubber particle interfaces.

### Example 2

To evaluate the degree to which air is entrained by the selected surfactants during mixing, a series of foaming tests were conducted. A Waring blender was used to mix 200 mL of water solutions containing two different concentrations of surfactants, 0.04 wt % and 0.1 wt %. To reproduce the same mixing speeds used in standard API procedures for cement slurries, the solutions were first mixed at 4000 revolutions per minute (rpm) for 35 seconds and subsequently at 12,000 rpm for the same period of time. After mixing, the volumes of each of the solutions was measured in graduated cylinders as a function of time to determine the quantity of air bubbles generated during mixing and retained in the solution.

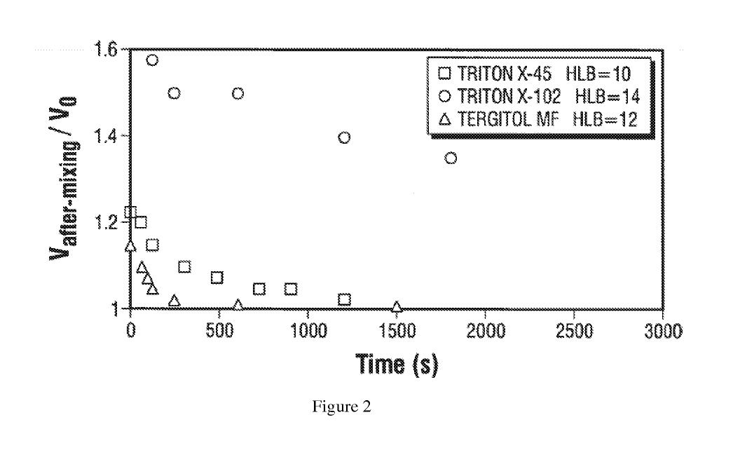

On the graph of FIG. 2, the ratio between the volume measured after mixing, V_{after-mixing}, and the initial volume, V₀, is plotted as a function of time for solutions containing 0.04% of surfactant. For each of the three surfactants tested, the ratio V_{after-mixing}/V₀ was highest right after mixing, at t=0, and then generally decreased with time. This suggests that air bubbles were present in the solutions after mixing and that an initial foam was generated, which resulted in a solution volume increase. The graphs further indicate that the ratio V_{after-mixing}/V₀ generally stabilized after an initial time period, meaning that air bubbles collapsed and the foam dissipated.

FIG. 2 suggests that, for the surfactant Tergitol™ MinFoam, the amount of air entrained in the solution was less problematic as the initial volume, V₀, was relatively low and the solution returned to the initial volume after a few minutes. Or, the air bubbles in the solution collapsed soon after mixing and the foam generated at mixing dissipated relatively quickly. By contrast, the solution containing Triton™ X-102 appeared to generate more air bubbles during mixing and tended to maintain the bubbles to a larger degree than the other solution. In fact, this solution maintained a volume increase higher than 40% even after 20 minutes.

Water solutions were then provided with higher concentrations (0.1 wt %) of the same surfactants and mixed as before. At t=0, the amount of foam observed in each of the water solution having the Triton™ surfactants was higher than as observed at the lower concentration (0.04%). For the solution containing Tergitol™ MinFoam at the higher concentration, the amount of foam observed was comparable to the amount observed in the solution containing the lower concentration of the non-ionic surfactant. For each of the solutions having the higher concentration of surfactant, the rate at which the volume of solution decreased with time corresponded well with what was observed at the lower concentration. In other words, more foam was generated initially, but the foam dissipated in the same manner as observed for solutions with the lower concentration of surfactant.

### Example 3

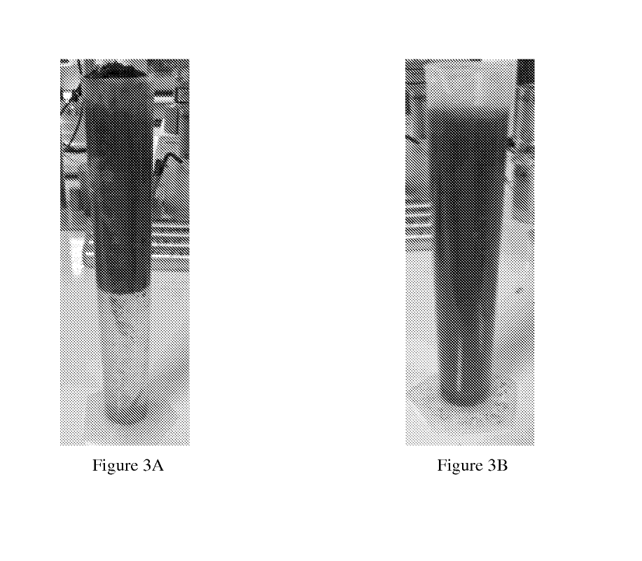

The purpose of a further experiment was to determine the effect of the addition of the surfactant on the dispersion of rubber particles in water, and on the mixability of a cement slurry. The rubber particles, made from ground rubber tires, were between about 70 and 500 microns in size. FIGS. 3A and 3B provide two depictions of a column of a water solution incorporating additives in the form of hydrophobic rubber particles. The first depiction in FIG. 3A, shows the water solution exhibiting two clearly distinguishable phases: a rubber particle phase and a water phase. In FIG. 3B, the hydrophobic rubber particles have been mixed directly in a water solution containing 0.04 wt % of Tergitol™ MinFoam. In clear contrast to the first solution without the surfactants, a single phase is observed indicating homogeneous dispersion of the polymeric particles in the water solution. This dispersion remained stable for more than 48 hours.

This example establishes, therefore, that the addition of the selected non-ionic surfactants renders the hydrophobic rubber particles readily dispersible in the water solution. This suggests, as well, that the addition the non-ionic surfactants in cement slurry incorporating hydrophobic polymer particles will encourage dispersion of the polymer particles in the solution and good mixability of the cement slurry composition.

### Example 4

In order to determine the effect of the presence of the surfactant on the mixability of a cement slurry, a slurry design containing rubber particles was studied. The same rubber particles described in Example 3 were used. In a preliminary base test, the slurry was mixed according to the following laboratory procedure. The dry blend, containing all the solid additives including an antifoam additive, was added to the liquid phase while mixing at 4000 rpm and the time required to fully incorporate the solids was measured. More than 5 minutes were required in this case.

Then, a nonionic surfactant, Tergitol™ MinFoam, was added to the water solution at a concentration of about 0.1 wt %. Also, the antifoam additive was removed from the formulation, to isolate possible entrainment of air caused by the surfactant. After the new design was mixed following the same procedure, the mixed solution was observed to be without foam. The time required to incorporate the solid was about 2 minutes in this case, which is considerably a shorter period that what was required in the first case. This establishes that the addition of the non-ionic surfactant improved the mixability of the cement slurry even without the presence of an antifoam agent.

TABLE 3
Slurry Design Comprising Rubber Particles

| Code | Concentration | Mass (g/600 mL) |
|---|---|---|
| DRY PHASE | (total = 657 g) | SVF = 55% |
| Class G cement | 34.7% BVOB* | 366.54 |
| Rubber | 24.0% BVOB | 95.04 |
| Additive 1 | 26.3% BVOB | 65.07 |
| Additive 2 | 35% BVOB | 131.18 |
| WET PHASE | (total = 269.3 g) | |
| Antifoam agent | 4.44 L/tonne (VBWOC)** | 1.63 |
| Cement dispersant | 1.00 L/tonne (VBWOC) | 0.45 |
| Fresh Water | 407.40 L/tonne of blend | 267.2 |

*BVOB: By Volume Of Blend;
**VBWOC: Volume by weight of cement

### Example 5

Additional tests were performed to investigate the effects of surfactants on the mixability of cement slurries containing hydrophobic particles. This time the speed of the Waring blender was decreased from 4,000 RPM to 1,000 RPM.

The composition of the dry blend is shown in Table 4.

TABLE 4
Dry blend composition

| Material | % by volume of blend |
|---|---|
| Class G cement | 30.8 |
| polypropylene copolymer | 59.8 |
| silica | 8.8 |
| calcium/magnesium oxide | 0.7 |

The polypropylene copolymer was Icorene™ 9013P, available from ICO Polymers. The particle size of the copolymer is: 5 wt % maximum particles larger than 800 m, and 15% maximum particles smaller than or equal to 200 m.

Two non-ionic surfactants were tested: TERRAVIS™ M5 (HLB=10.5), available from SASOL and Rhodasurf™ BC 840 (HLB=15.4), available from Rhodia. The results are presented in Table 5.

TABLE 5
Mixing test results.

| | Mix fluid composition | | | | |
|---|---|---|---|---|---|
| | | | Surfactant | Surfactant | |
| | Antifoam | Cement | TERRAVIS ™ | Rhodasurf ™ | |
| | Agent | Dispersant | M5 | BC 840 | |
| De- | [L/tonne, | [L/tonne, | [L/tonne, | [L/tonne, | Mixing |
| sign | BWOB*) | BWOB) | BWOB) | BWOB) | time [s] |
| 1 | 4.17 | 5 | — | — | 167 ± 4 |
| 2 | | | 2.3 | — | 122 ± 1 |
| 3 | | | — | 2.3 | 82 ± 5 |

*BWOB = by weight of solid blend

The presence of a surfactant, particularly Rhodasurf™ BC 840, shortened the time to incorporate all of the solids into the liquid phase of the slurry.

### Example 6

Tests were performed to determine the effect of surfactants on the maximum attainable solid volume fraction (SVF) or slurry density for a particular slurry design. Cement blends containing hydrophobic particles were prepared and added to mix fluids with and without surfactants.

The mixing was performed in a Waring blender at 1000 RPM and 4000 RPM. Dry cement blends were added to the mixer until it was no longer possible to maintain a vortex in the fluid. The maximum attainable SVF was calculated from the total weight of blend incorporated during the mixing. The dry blend composition is shown in Table 6.

TABLE 6
Dry blend composition

| Material | % by volume of blend |
|---|---|
| Class G cement | 34.8 |
| polypropylene copolymer | 54.6 |
| silica | 9.9 |
| calcium/magnesium oxide | 0.7 |

The base mixing fluid was fresh water containing an antifoam agent and a polynaphthalene sulfonate cement dispersant. The surfactant was Rhodosurf™ BC 840. Results are presented in Table 7.

TABLE 7
Slurry compositions.

| | Mix fluid composition | | | | | | |
|---|---|---|---|---|---|---|---|
| | Antifoam | Dispersant | Surfactant | Maximum SVF at | Maximum density | Maximum SVF at | Maximum density |
| | [L/tonne, | [L/tonne, | [L/tonne, | 1000 RPM [%] | at 1000 RPM | 4000 RPM [%] | at 4000 RPM |
| Design | BWOB) | BWOB) | BWOB) | ±0.05 | [lbm/gal] (kg/m³) | ±0.05 | [lbm/gal] (kg/m³) |
| 1 | 4.17 | 10 | 0 | 57 | 12.6 | 59.8 | 13.3 |
| | | | | | (1510) | | (1600) |
| 2 | | | 4.17 | 57.9 | 12.8 | 60.8 | 13.5 |
| | | | | | (1540) | | (1620) |
| 3 | | | 0 | 55 | 12.2 | 57.8 | 12.85 |
| | | | | | (1460) | | (1540) |
| 4 | | | 4.14 | 55.7 | 12.35 | 58.5 | 13.0 |
| | | | | | (1480) | | (1560) |

The presence of surfactant in the mix fluid increased the maximum attainable SVFs and slurry densities.

### Example 7

Testing was performed to evaluate surfactants' ability to improve the mixing of cement slurries containing the hydrophobic asphaltite mineral unitaite, more commonly known as Gilsonite™, available from American Gilsonite Company. The particle size of the unitaite additive varied between about 90 and 2400 microns. The base slurry composition was made from TXI Light-Weight cement—a proprietary blend of pulverized portland cement clinker, pozzolan and calcium sulfate, available from Texas Industries, Inc. The complete slurry composition including addtives is presented in Table 8. Sufficient water was added to achieve a slurry density of 10.7 lbm/gal (1280 kg/m³).

TABLE 8
Base-slurry composition

| Material | Concentration |
|---|---|
| TXI Light-Weight cement | 21.04% BVOB* |
| unitaite | 73.21% BVOB |
| silica | 5.74% BVOB |
| antifoam agent | 0.02 gal/sack** |
| | (1.78 L/tonne) |
| naphthalene sulfonate | 0.1% BWOB*** |
| dispersant | |
| cellulose/AMPS fluid-loss | 0.2% BWOB |
| additive | |
| lignosulfonate retarder | 0.35% BWOB |
| polypropylene glycol | 0.2% BWOB |

*BVOB = by volume of solid blend; 1 sack = 42 kg;
***BWOB = by weight of solid blend

Mixing tests were performed to determine the length of time required to prepare a homogeneous cement slurry in a Waring blender at 4000 RPM. The concentration of TERRAVIS™ M5 surfactant was varied from 0.0 to 0.1 gal/sack (0.0 to 8.9 L/tonne). The results are presented in Table 9.

TABLE 9
Slurry mixing times versus surfactant concentration.

| TERRAVIS ™ M5 | Mixing time at |
|---|---|
| concentration (L/tonne) | 4000 RPM (sec) |
| 0.00 | 1.42 |
| 2.23 | 0.50 |
| 4.45 | 0.43 |
| 6.68 | 0.34 |
| 8.90 | 0.21 |

Although various embodiments have been described within respect to enabling disclosures, it is to be understood the disclosed embodiments are not limiting. Variations and modifications that would occur to one of skill in the art upon reading the specification are also within the scope of the disclosure, which is defined in the appended claims.

1. A composition, comprising:
(i) an inorganic cement;
(ii) water;
(iii) organic polymer particles with an average particle size between 1 micron and 1000 microns; and
(iv) a non-ionic surfactant.

2. The composition of claim 1, wherein the non-ionic surfactant comprises a hydrophilic part that contains ethoxylate groups and propoxylate groups.

3. The composition of claim 1, wherein the non-ionic surfactant is an octylphenol ethoxylate.

4. The composition of claim 3, wherein the non-ionic surfactant contains between 4.5 moles and 12 moles of ethylene oxide.

5. The composition of claim 3, wherein the non-ionic solvent has a hydrophilic-lipophilic balance (HLB) value between 10 and 14.

6. The composition of claim 1, wherein the organic polymer additives comprise rubber particles and the non-ionic surfactant comprises ethoxylate groups and has an HLB value between 10 and 16.

7. The composition of claim 1, wherein the non-ionic surfactant comprises one or more members selected from the group consisting of non-ionic surfactants containing ethoxylate groups; non-ionic surfactants containing both ethoxylate groups and propoxylate groups; alkoxylates containing propylene oxides; and alkoxylates containing butylene oxide.

8. The composition of claim 1, wherein the organic polymer additives are unitaite particles.

9. The composition of claim 1, further comprising an anti-foam agent and a dispersant.

10. The composition of claim 1, wherein the organic polymer particles are present at a concentration between 5% and 40% by weight, and the non-ionic surfactant is present at a concentration between 0.005% and 5% by weight.

11. The composition of claim 10, wherein the non-ionic surfactant is present at a concentration of between 0.05% and 0.5% weight, and the cement is present at a concentration of between 10% and 50% by weight.

12. A method for cementing a subterranean well comprising a borehole, comprising:
(i) preparing a cement slurry composition comprising an inorganic cement, water, organic polymer particles and a non-ionic surfactant;
(ii) pumping the cement slurry composition into the subterranean well and placing the composition in a zone of the subterranean well; and
(iii) allowing the cement slurry composition to set and form a solid mass in the zone, wherein, the organic polymer particles have an average particle size between 1 micron and 1000 microns.

13. The method of claim 12, wherein the non-ionic surfactant comprises ethoxylate groups and propoxylate groups in the hydrophilic part.

14. The method of claim 12, wherein preparing the cement slurry composition further comprises:
(iv) preparing a dry blend comprising the cement and organic polymer particles;
(v) preparing a wet blend comprising the water and the non-ionic surfactant; and
(vi) mixing the dry blend and wet blend at a water-to-cement ratio suitable to prepare a pumpable base slurry.

15. The method of claim 14, wherein preparing the cement slurry composition includes employing a jet mixer to mix the dry blend and the liquid blend in a continuous mixing mode.

16. The method of claim 12, wherein the polymer particles comprise rubber particles and the non-ionic surfactant comprises ethoxylate groups.

17. The method of claim 12, further comprising, prior to preparing the cement slurry composition, providing a non-ionic surfactant comprising one or more members selected from the group consisting of non-ionic surfactants containing ethoxylate groups; and non-ionic surfactants containing both ethoxylate groups and propoxylate groups.

18. The method of claim 12, wherein the cement slurry composition comprises between 5% to 40% by weight of the polymer particles and between 0.05% and 0.5% by weight of the non-ionic surfactant.

19. A method for improving the preparation of a cement slurry composition having hydrophobic organic polymer particles therein for introduction into a subterranean well, comprising:
(i) preparing a dry blend comprising an inorganic cement and organic polymer particles, the particles having an average particle size between 1 micron and 1000 microns;
(ii) preparing a water solution;
(iii) adding a non-ionic surfactant into the water solution; and
(iv) using a continuous mixing method to mix the dry blend into the water solution, whereby the non-ionic surfactant acts to disperse the polymer particles in the solution.

20. The method of claim 19, wherein the polymer particles comprise rubber particles and the non-ionic surfactant comprises both ethoxylate groups and propoxylate groups in the hydrophilic part, the non-ionic surfactant being added to constitute between 0.05% and 0.5% by weight non-ionic surfactant in the cement slurry composition.
